(19) United States
(12) Patent Application Publication
(10) Pub. No.: US 2010/0207820 A1
(43) Pub. Date: Aug. 19, 2010

(54) DISTANCE MEASURING DEVICE

(75) Inventors: Minori Kawano, Hyogo (JP); Yasunori Takeuchi, Hiroshima (JP); Hironori Kawano, Amagasaki-shi (JP)

Correspondence Address: HARNESS, DICKEY & PIERCE, P.L.C., P.O. BOX 828, BLOOMFIELD HILLS, MI, 48303, US

(73) Assignee: RADIO COMMUNICATION SYSTEMS LTD., Amagasaki-shi (JP)

(21) Appl. No.: 12/439,962

(22) PCT Filed: Sep. 4, 2007
(86) PCT No.: PCT/JP2007/067235

§ 371 Date: Apr. 29, 2009

(30) Foreign Application Priority Data
Sep. 5, 2006 (JP) 2006-240101
Nov. 13, 2006 (JP) 2006-306405
Dec. 12, 2006 (JP) 2006-335162
Jan. 15, 2007 (JP) 2007-005379
Feb. 6, 2007 (JP) 2007-027385
Mar. 28, 2007 (JP) 2007-084798

(51) Int. Cl. G01S 1/22; H04B 1/00; G01C 3/08

(52) U.S. Cl. 342/393; 375/132; 356/5.09; 375/E01.033

(57) ABSTRACT

Problems The present invention relates to a distance measuring device that measures the distance between a single signal transmitting means and a single signal receiving means with high accuracy by the signal transmitting means transmitting radio frequency signals.

Means for Solving the Problems A distance measuring device is comprised of a signal transmitting means (101), a signal receiving means (102) and a signal processing means (103). The signal transmitting means transmits radio frequency signals, the components of which are a plurality of measuring signals in synchronization with an output reference signal of a reference oscillator (7). The signal receiving means (102) generates a first local oscillating signal in synchronization with an output reference signal of a reference oscillator (34), mixes the first local oscillating signal with a received signal, converts the mixed signal to first intermediate signals with at least a plurality of different frequencies, mixes the first intermediate signals corresponding to the measuring signals with a plurality of second local oscillating signals with at least different frequencies in synchronization with or orthogonal to an output signal of a second mixer (35), and converts the mixed signal to a plurality of second intermediate signals. The signal processing means (103) detects a phase difference of the second intermediate signals and measures the distance between the signal transmitting means (101) and the signal receiving means (102) with high accuracy.

### TECHNICAL FIELD

The present invention relates to a distance measuring device that measures the distance between a single signal transmitting means and a single signal receiving means with high accuracy by the signal transmitting, means transmitting a plurality of ultrasonic signals, radio frequency signals or optical signals that differ at least in frequency and the signal receiving means receiving the signals.

### BACKGROUND ART

Distance measuring systems based on a plurality of radio signals at different frequencies have already been proposed (see the Patent Documents 1 to 5, for example).

Patent Document 1: U.S. Pat. No. 4,087,816

Patent Document 2: Japanese Patent Laid-Open No. 2003-207557

Patent Document 3: National Publication of International Patent Application No. 2006-507714

Patent Document 4: Japanese Patent Laid-Open No. 2006-023261

Patent Document 5: Japanese Patent Laid-Open No. 2006-0042201

FIG. 11 shows an embodiment of a conventional “VLF radio position location system” described in the Patent Document 1. In FIG. 11, a VLF signal transmitted from the US Navy VLF communication station (a radio wave frequency-shift keyed in a range of f0 to f0+50 Hz in a cycle of 20 msec) is received at an antenna 10, amplified by an amplifier 11 and then mixed by a mixer 16 with a signal from a synthesizer 23 synchronized with a VCXO 22 to produce an intermediate frequency signal, the resulting intermediate frequency signal is amplified by an intermediate frequency amplifier 12, limited by a limiter 18 and then compared by a phase comparator 20 with a signal from the VCXO 22 frequency-divided by P by a frequency divider 24, the result of the comparison is input to a loop filter 21, and the oscillation frequency of the VCXO 22 is controlled based on the output of the loop filter 21.

In addition, the output of the limiter 18 is compared by a delay time measurement device 25 with the output of the frequency divider 24 at the timing when the output of the frequency divider 24 is frequency-divided by 20 by the frequency divider 27. The distance from the communication station can be measured based on the detected delay time.

The conventional technique shown in FIG. 11 has a problem that it is difficult to achieve high accuracy in relatively short distance measurement within a range of 300 m without modification, although it can achieve approximate long distance measurement, because it is difficult for the receiver to detect the time of change of the frequency of the VLF signal between f0 and f0+50 Hz without error.

In the conventional “mobile station and mobile body communication system” described in the Patent Document 2, fixed stations transmit two distance measuring signals having different frequencies to a mobile terminal by radio, the mobile terminal calculates the position thereof by measuring the distance between the mobile terminal and three fixed stations based on the phase difference between the two distance measuring signals transmitted from each fixed station.

As described in the paragraph [0012] in the Patent Document 2, the mobile terminal receives two frequency-hopping modulated distance measuring signals transmitted by radio from the fixed stations and measures the phase difference between the two distance measuring signals. A specific procedure of measuring the phase difference is shown in FIG. 2.

According to the method described above, as shown in FIG. 2, the phase of the two distance measuring signals having different frequencies starts to change at a transmission start point 0, and therefore, it is essential that the mobile terminal is synchronized with the fixed stations and knows the timing of the transmission start point 0.

However, it is difficult to detect the transmission start point 0 from the two distance measuring signals transmitted from a single fixed station with high accuracy. Thus, it is essential that the mobile terminal receives the distance measuring signals from three fixed stations synchronized with each other. Thus, there is a problem that the three fixed stations have to be synchronized with each other, and the mobile terminal has to be able to receive the distance measuring signals from the three fixed stations simultaneously or in a short time.

In the conventional “distance measurement/ranging based on determination of RF phase delta” described in the Patent Document 3, the distance between a first transponder and a second transponder is measured by the first transponder transmitting a first signal having a first frequency and a second signal having a second frequency to the second transponder and the second transponder determining the phase difference between the two signals.

However, in order to compare the two signals and determine the phase difference between the two signals, the second transponder generates a reference signal phase-locked to the first signal and generates a mixture signal by mixing the reference signal and the second signal, and a counter counts the number of nulls or peaks in the mixture signal.

Thus, the distance measurement accuracy depends on the intervals of occurrence of the nulls or peaks. As described in the paragraph [0025], in the case where the first signal has a frequency of 880 MHz, and the second signal has a frequency of 884 MHz, the nulls or peaks occur at intervals of 75 m, and the distance measurement accuracy is ±37.5 m.

Although a method of improving the distance measurement accuracy is described in the paragraph [0026], there is a problem that there is a theoretical limit to the accuracy improvement, and it is difficult to improve the accuracy to the order of centimeters.

In the conventional “active tag device” described in the Patent Document 4, it is disclosed that a transmitting means or relay means transmits synchronized or orthogonal ultrasonic signals, high frequency signals or optical signals hopped or switched between a plurality of carrier frequencies, sub-carrier frequencies, modulation frequencies or spread code rates.

However, although it is described that a receiving means detects the distance from the transmitting means or relay means, any specific means for implementing the transmitting means or receiving means is not described.

In the conventional “distance measurement system, distance measurement method and communication device” described in the Patent Document 5, a mobile terminal transmits two carriers having different frequencies, and another mobile terminal receives the two carriers by a receiver incorporated therein and calculates the distance between the two mobile terminal by detecting the phase difference ΔΦ between the two carriers.

However, the formulas (6) and (7) disclosed in the paragraph [0067] as a basis for determining the distance consider different frequencies f1 and f2, so that the phase difference ΔΦ varies with time, and therefore, the distance R disclosed in the paragraph [0071] varies with time.

This technique has a problem that the transmitter and the receiver have to be synchronized with each other in some way.

### DISCLOSURE OF THE INVENTION

### Problems to be Solved by the Invention

An object of the present invention is to provide an inexpensive distance measuring device that can measure the distance between a single signal transmitting means and a single signal receiving means with high accuracy by the signal transmitting means transmitting a plurality of ultrasonic signals, radio frequency signals or optical signals that differ at least in frequency and are synchronized with or orthogonal to each other and the signal receiving means receiving the signals, in which the signal receiving means converts the plurality of ultrasonic signals, radio frequency signals or optical signals transmitted from the signal transmitting means into common intermediate frequency signals, modulation signals or baseband signals and detects the frequency and/or phase of the intermediate frequency signals, modulation signals or baseband signals to measure the distance between the signal transmitting means and the signal receiving means.

### Means for Solving the Problems

A distance measuring device according to the present invention comprises at least one signal transmitting means, a signal receiving means and a signal processing means, in which the signal transmitting means transmits a plurality of ultrasonic signals, radio frequency signals or optical signals that differ at least in frequency and are synchronized with or orthogonal to each other,

the signal receiving means generates a plurality of local oscillating signals that differ at least in frequency and are synchronized with or orthogonal to each other and converts the plurality of received ultrasonic signals, radio frequency signals or optical signals into intermediate frequency signals, modulation signals or baseband signals having a common frequency by mixing with the plurality of local oscillating signals,

the signal processing means has a phase and frequency detector that detects the frequency and/or phase using a clock signal output from a synchronous oscillator and a synchronization establishing/retaining means that controls the frequency, phase and/or delay time of the clock signal output from the synchronous oscillator and establishes and retains a synchronization between the intermediate frequency signals, modulation signals or baseband signals and the clock signal,

the phase and frequency detector and the synchronization establishing/retaining means establishes a synchronized state between the clock signal and a first intermediate frequency signal, modulation signal or baseband signal corresponding to an ultrasonic signal, radio frequency signal or optical signal having a first frequency serving as a reference, detects the frequency and/or phase of a second intermediate frequency signal, modulation signal or baseband signal corresponding to a second ultrasonic signal, radio frequency signal or optical signal that differs from the ultrasonic signal, radio frequency signal or optical signal having the first frequency at least in frequency while retaining the synchronized state, and measures the distance between the signal transmitting means and the signal receiving means with high accuracy based on the result of the detection.

The distance measuring device described above can be modified in various ways. For example, the same advantages can be achieved if the signal receiving means generates a local oscillating signal having a fixed frequency and outputs a plurality of intermediate frequency signals, modulation signals or baseband signals having different frequencies, or the signal processing means performs frequency multiplication or division of the clock signal output from the synchronous oscillator.

### ADVANTAGES OF THE INVENTION

Conventional accurate distance measurement systems include a radar or transponder that measures the distance from a target by measuring the time taken for an ultrasonic signal, radio frequency signal or optical signal transmitted from a single signal transmitting means to be reflected or retransmitted from the target and received by a single signal receiving means and a “VLF radio position location system” that has a single signal transmitting means that transmits a FSK-modulated radio frequency signal and a single signal receiving means that receives the signal and measures the distance by detecting the delay time between the carrier signal and the FSK-modulated signal. However, these systems have problems that the systems are expensive, the distance measurement accuracy is low particularly for relatively short ranges of 300 m or less, and the systems takes a long time to measure the distance, for example.

To the contrary, the distance measuring device according to the present invention has advantages that direct distance measurement that involves no reflected or reradiated waves can be achieved using a single signal transmitting means that transmits an ultrasonic signal, radio frequency signal or optical signal and a single signal receiving means that receives the signal, relatively short distances of 300 m or less can be measured with high accuracy in real time, and the distance measuring device is inexpensive.

Furthermore, if a means of detecting the direction or the direction of movement is used in combination, the position of a mobile body can be advantageously spotted with high accuracy.

### BEST MODE FOR CARRYING OUT THE INVENTION

As shown in FIG. 1 and described in claims 1 and 5, a distance measuring device according to a first embodiment of the present invention is composed of a signal transmitting means 101, a signal receiving means 102 and a signal processing means 103.

In the signal transmitting means 101, a mixer 3 mixes a local oscillating signal having a fixed frequency, which is generated by synchronizing the oscillation frequency of a voltage-controlled oscillator 4 with a reference oscillator 7 by a phase synchronization loop composed of a frequency divider 6 and a phase comparator 5, with a plurality of orthogonal signals that differ at least in frequency and are synchronized with or orthogonal to each other and/or modulates the local oscillating signal with a synchronous signal to produce a plurality of carrier signals or sub-carrier signals, a power amplifier 2 amplifies the plurality of carrier signals or sub-carrier signals, and the plurality of carrier signals or sub-carrier signals are radiated into the space from an antenna 1 as radio frequency signals.

The plurality of carrier signals or sub-carrier signals can be simultaneously and/or sequentially produced by a control unit 9 controlling the time of mixing by the mixer 3 and the time of switching of at least the oscillation frequency of an orthogonal signal generator 8b.

In the signal receiving means 102, a first local oscillating signal having a fixed frequency is generated by processing the oscillation frequency of a reference oscillator 32 in a phase synchronization loop composed of a frequency divider 32 and a phase comparator 33, the first local oscillating signal is applied to a first mixer 16 and mixed with a signal received at an antenna 10 and amplified by a low noise amplifier 11 to form a plurality of first intermediate frequency signals, the first intermediate frequency signals are amplified by an amplifier 17 and converted into second intermediate frequency signals by a second mixer 35, and the second intermediate frequency signals are input to the signal processing means 103.

In the signal processing means 103, a synchronous signal detector 51 detects the synchronous signals from the second intermediate frequency signals and makes a control unit 54 start a control timing.

Since the signal transmitting means 101 transmits a plurality of carrier signals or sub-carrier signals using the synchronous signals as a timing reference, the control unit 54 sets a frequency in an orthogonal signal transmitter 55 and waits.

Once the synchronous signals are detected, the control unit 54 controls at least the oscillation frequency of the orthogonal signal generator 55 at a previously determined time, the synchronous signals are supplied to the second mixer 35 and mixed with the first intermediate frequency signals to form a plurality of second intermediate frequency signals at a common frequency.

During reception of a first carrier signal or sub-carrier signal used as the reference, a synchronization is established between a first second intermediate frequency signal corresponding to the carrier signal of a first frequency or sub-carrier signal and a clock signal generated by a synchronous oscillator 54, a phase and frequency detector 52 detects the frequency and/or phase of the first second intermediate frequency signal while retaining the synchronized state, the phase and frequency detector 52 then detects the frequency and/or phase of a second second intermediate frequency signal corresponding to a received second carrier signal or sub-carrier signal that differs from the first carrier signal or sub-carrier signal at least in frequency, and the distance between the signal transmitting means 101 and the signal receiving means 102 can be measured with high accuracy based on the result of the detections.

As shown in FIG. 3 and described in claim 3, according to an second embodiment of the present invention, the same advantages can be achieved by providing a frequency multiplier 56 that multiplies or divides the frequency of the output signal of the synchronous oscillator 53 in the signal processing means 103, instead of changing the frequency of the orthogonal signal generator 55 in the signal receiving means 102.

Furthermore, if a synchronous oscillator 53, the configuration of which is shown in FIG. 8 and described in claim 11, is used, a synchronization can be established between two input signals, and the synchronization can be stably retained.

Furthermore, as shown in FIG. 8 and described in claim 26, according to a third embodiment of the present invention, if the signal transmitting means 101 and/or signal receiving means 102 has a plurality of antennas or transceivers, and the plurality of antennas or transceivers are switched by a switching means, additional advantages are provided that the distance between the signal transmitting means 101 and the signal receiving means 102 can be measured with higher accuracy, the direction of the position of the signal transmitting means 101 and/or signal receiving means 102 can be determined, and therefore, the current position of the signal receiving means 102 can be spotted with higher accuracy.

### Embodiment 1

FIG. 1 is a block diagram showing a distance measuring device according to a first embodiment of the present invention, and FIG. 2 is a diagram showing exemplary flows of signals. In FIG. 1, reference numeral 101 denotes a signal transmitting means, reference numeral 1 denotes an antenna, reference numeral 2 denotes a power amplifier, reference numeral 3 denotes a mixer, reference numeral 4 denotes a voltage-controlled oscillator, reference numeral 5 denotes a phase comparator, reference numeral 6 denotes a frequency divider, reference numeral 7 denotes a reference oscillator, reference numeral 8a denotes a synchronous signal generator, reference numeral 8b denotes an orthogonal signal generator, and reference numeral 9 denotes a control unit. Furthermore, reference numeral 102 denotes a signal receiving means, reference numeral 10 denotes an antenna, reference numeral 11 denotes a low noise amplifier, reference numeral 16 denotes a first mixer, reference numeral 17 denotes a first intermediate frequency amplifier, reference numeral 31 denotes a voltage-controlled oscillator, reference numeral 32 denotes a frequency divider, reference numeral 33 denotes a phase comparator, reference numeral 34 denotes a reference oscillator, and reference numeral 35 denotes a second mixer. Furthermore, reference numeral 103 denotes a signal processing means, reference numeral 51 denotes a synchronous signal detector, reference numeral 52 denotes a phase and frequency detector, reference numeral 53 denotes a synchronous oscillator, reference numeral 54 denotes a control unit, reference numeral 55 denotes an orthogonal signal generator, and reference numerals 61, 62 and 63 denote connection points.

In the signal transmitting means 101, the oscillation frequency and phase of the voltage-controlled oscillator 4 are locked to the frequency and phase of the reference oscillator 7 by a phase locked loop composed of the frequency divider 6 and the phase comparator 5. The voltage-controlled oscillator 4 generates a carrier signal or sub-carrier signal, the carrier signal or sub-carrier signal is mixed with or modulated with a synchronous signal and/or orthogonal signal generated by the synchronous signal generator 8a, and the resulting signal is amplified by the power amplifier 2 and radiated into the space from the antenna 1 as a radio frequency signal.

At least the oscillation frequency of the orthogonal signal generator 8b is periodically switched under the control of the control unit 9, and a first orthogonal signal set at a first control start point 203a in FIG. 2 and a second orthogonal signal 202 set at a second control start point 203b are generated, in synchronization with or orthogonally to each other, to at least have different frequencies.

Since the signal transmitting means 101 is configured as, described above, radio frequency signals that have a header part modulated with the synchronous signal and are mixed with or modulated with a plurality of orthogonal signals that differ at least in frequency and are synchronized with or orthogonal to each other at a timing strictly controlled by the control unit 9 are radiated as bursts.

On the other hand, in the signal receiving means 102, the oscillation frequency and phase of the voltage-controlled oscillator 31 are locked to the frequency and phase of the reference oscillator 34 by a phase locked loop composed of the frequency divider 32 and the phase comparator 33. The voltage-controlled oscillator 31 generates a local oscillating signal and applies the local oscillating signal to the first mixer 16, the first mixer 16 mixes the local oscillating signal with the signals received at the antenna 10 and amplified by the low noise amplifier 11 to convert the local oscillating signal into a plurality of first intermediate frequency signals at different frequencies, the first intermediate frequency amplifier 17 amplifies the first intermediate frequency signals, the second mixer 35 mixes the first intermediate frequency signals with a plurality of orthogonal signals that differ at least in frequency and are supplied via the connection point 63 to convert the first intermediate frequency signals into second intermediate frequency signals that at least fall within a common frequency band, and the second intermediate frequency signals are output to the signal processing means 103 via the connection point 61.

The signal processing means 103 is composed of the synchronous signal detector 51 that detects a synchronous signal from the second intermediate frequency signal output from the signal receiving means 102, the orthogonal signal generator 55 that supplies an orthogonal signal to the second mixer, the phase and frequency detector 52 that performs frequency and/or phase detection, the synchronous oscillator 53 that supplies a clock signal to the phase and frequency detector 52, and the control unit 54.

As shown in the circuit diagram of FIG. 9, the synchronous oscillator 53 incorporates a synchronization establishing means that establishes synchronization of the frequency and/or phase of the second intermediate frequency signal with the frequency and/or phase of the clock signal generated by the synchronous oscillator 53, a synchronization detecting means that detects a synchronization, and a synchronization retaining means that retains a synchronization.

The phase and frequency detector 52 detects the frequency and/or phase of the input signal by converting the second intermediate frequency signals into digital signals in a cycle of the clock signal and calculating the sum of products thereof using a sine and a cosine look-up table or performing fast Fourier transformation as shown in FIG. 6 or converting the second intermediate frequency signals into IQ signals and then achieving the zero beat as shown in FIG. 7, for example.

When the signal transmitting means 101 transmits a first radio frequency signal corresponding to the first orthogonal signal containing the synchronous signal at the first control start point, the synchronous signal detector 51 in the signal processing means 103 detects the synchronous signal, and the control unit 54 activates the control timing.

When the synchronization detecting means incorporated in the synchronous oscillator 53 detects a synchronization of the clock signal output from the synchronous oscillator 53 with a first second intermediate frequency signal corresponding to the first orthogonal signal transmitted from the signal transmitting means 101, the synchronization retaining means incorporated in the synchronous oscillator 53 retains the frequency and/or phase of the clock signal.

While the synchronous oscillator 53 is retaining the synchronized state, the phase and frequency detector 52 detects the frequency and/or phase of the first second intermediate frequency signal, the signal transmitting means 101 then radiates second radio frequency signals into the space corresponding to the second orthogonal signals that differ at least in frequency at the second control start point, the control unit 54 in the signal processing means 103 switches the frequency of the orthogonal signal generator 55, the second orthogonal signals are supplied to the second mixer 35 in the signal receiving means 102 via the connection point 63, and the phase and frequency detector 52 detects the frequency and/or phase of a second second intermediate frequency signal, and the distance between the signal transmitting means 101 and the signal receiving means 102 can be measured with high accuracy based on the result of the detection.

Provided that the first radio frequency signal and the second radio frequency signal transmitted from the signal transmitting means 101 are represented as aSin(2πf1t) and aSin(2πf2t), respectively, the first radio frequency signal and the second radio frequency signal received by the signal receiving means 102 are represented as ASin{2πf1t+(2πD/λ1)} and ASin{2πf2t+(2πD/λ2)}, respectively, where D represents the distance(m) from the signal transmitting means 101. Here, it is supposed that λ1 represents the wavelength of the first radio frequency signal, and λ2 represents the wavelength of the second radio frequency signal.

Provided that the first orthogonal signal generated in the signal processing means 103 to correspond to the first radio frequency signal and the second orthogonal signal generated in the signal processing means 103 to correspond to the second radio frequency signal in the processes of conversion into the first intermediate frequency signals having different frequencies and conversion into the second intermediate frequency signals by mixing with a plurality of orthogonal signals having different frequencies supplied from the signal processing means 103 by the second mixer in the signal receiving means 102 are represented as Bsin(2πfL1t+φ) and Bsin(2πfL2t+φ), respectively, the first second intermediate frequency signal is represented as ABSin{2πfit+(2πD/λ1)−φ}, and the second second intermediate frequency signal is represented as ABSin{2πfit+(2πD/λ2)−φ}. Here, it is supposed that fi=f1−fL1, fi=f2−fL2.

Comparison between the first second intermediate frequency signals and the second second intermediate frequency signal shows that the signals are the same in frequency but differ in phase. Thus, if the first second intermediate frequency signal and the second second intermediate frequency signal are received simultaneously, the phase difference can be measured independently of the timing of measurement.

However, in practice, two receivers are needed to simultaneously receive the first second intermediate frequency signal and the second second intermediate frequency signal, and the difference in characteristics between the two receivers degrades the accuracy of distance measurement. Therefore, the phase difference between the first second intermediate frequency signal and the second second intermediate frequency signal have to be measured by alternately receiving the signals.

Thus, if, as a control start point of measurement of the phase difference between the first second intermediate frequency signal and the second second intermediate frequency signal, t1 is set for the first second intermediate frequency signal, and t2 is set for the second second intermediate frequency signal, the problem can be solved by the control unit 54 strictly controlling the interval between t1 and t2.

If the synchronized state described above is retained, the first second intermediate frequency signal and the second second intermediate frequency signal are the same in frequency but differs in phase by an amount equivalent to the distance D(m). The phase difference Δφ is represented as Δφ=(2πD/λ1)−(2πD/λ2)=2πD{(1/λ1)−(1/λ2)}=(D/C){2π(f1−f2)}. The distance D(m) between the signal transmitting means 101 and the signal receiving means 102 can be determined by the following formula: D=(C×Δφ)/{2π(f1−f2)}. In this formula, C represents the speed of light.

For example, provided that f1−f2=5 MHz, when the distance between the signal transmitting means 101 and the signal receiving means 102 is 60 m, the phase difference between the first second intermediate frequency signal and the second second intermediate frequency signal is 360 degrees. Therefore, if the measurement accuracy of the phase difference is ±0.5 degrees, the distance measurement accuracy is ±8 cm for the distance of 60 m. Thus, distance measurement can be achieved with high accuracy.

If the synchronization is not established or retained, the distance measurement accuracy decreases.

Thus, provided that the frequency shift of the delay synchronization loop oscillator 54 is represented by Δf, when the frequency of the plurality of carrier signals or sub-carrier signals transmitted from the signal transmitting means is changed from f1 to f2 and then to f1, the detected phase difference is (f1−f2+Δf)−(f2−f1+Δf)=2(f1−f2). Thus, the frequency shift Δf can be reduced.

When the frequency of the plurality of carrier signals or sub-carrier signals transmitted from the signal transmitting means is changed from f1 to f2 and then to f1, the orthogonality can be advantageously easily established or retained, if the intervals between the control starts points for the plurality of carrier signals or sub-carrier signals are equal to or integral multiples of each other, and the number of cycles of the plurality of carrier signals or sub-carrier signals generated at intervals of the control start points are integral multiples of or equal to each other.

However, if the frequency shift exceeds one cycle during measurement, the phase difference also exceeds 360 degrees to make the distance measurement unstable, the synchronization has to be established and retained in order to prevent the frequency shift from exceeding one cycle during measurement.

A plurality of synchronized or orthogonal radio frequency signals can be equally advantageously generated by frequency hopping, FSK modulation, amplitude modulation of the carrier signals or sub-carrier signals using a modulation signal or baseband signal, double side band modulation or repeated single side band modulation.

A case where the signal transmitting means 101 transmits a radio frequency signal has been described above. However, the same advantages can be achieved if the signal transmitting means 101 transmits an ultrasonic signal or optical signal.

As can be seen from the example shown in FIG. 8, the oscillator in the synchronous oscillator 53 incorporates not only the signal oscillator capable of controlling the frequency and/or phase and retaining a particular frequency and/or phase but also a phase comparator, a synchronization establishing means, a synchronization detecting means and a synchronization retaining means, for example.

Furthermore, if the orthogonal signal generator 55 is provided in the signal receiving means 102, or the second mixer 35 is provided in the signal processing means 103, the same advantages can be achieved.

Preferably, the plurality of radio frequency signals that differs at least in frequency and are synchronized with or orthogonal to each other generated by the signal transmitting means 101 are composed of a variable part (an orthogonal signal) and a fixed part (a local oscillating signal), and the plurality of local oscillating signals that differ at least in frequency and are synchronized with or orthogonal to each other generated by the signal receiving means 102 are composed of a variable part (an orthogonal signal) and a fixed part (a local oscillating signal), at least the variable part generated by the signal transmitting means 101 and the variable part generated by the signal receiving means are identical, similar or analogous to each other.

The frequency difference between the fixed part generated by the signal transmitting means 101 and the fixed part generated by the signal receiving means 102 is preferably equal to the first intermediate frequency and/or the second intermediate frequency in the signal receiving means 102.

### Embodiment 3

FIG. 3 is a diagram showing a distance measuring device according to an embodiment 2 of the present invention. In FIG. 3, reference numeral 102 denotes a signal receiving means, reference numeral 10 denotes an antenna, reference numeral 11 denotes a low noise amplifier, reference numeral 16 denotes a mixer, reference numeral 17 denotes an intermediate frequency amplifier, reference numeral 31 denotes a voltage-controlled oscillator, reference numeral 32 denotes a frequency divider, reference numeral 33 denotes a phase comparator, reference numeral 35 denotes a reference oscillator, reference numeral 103 denotes a signal processing means, reference numeral 51 denotes a synchronous signal detector, reference numeral 52 denotes a phase and frequency detector, reference numeral 53 denotes a synchronous oscillator, reference numeral 54 denotes a control unit, reference numeral 56 denotes a frequency multiplier/divider, and reference numerals 61 and 62 denote connection points.

In the signal receiving means 102, the oscillation frequency and phase of the voltage-controlled oscillator 31 are locked to the frequency and phase of the reference oscillator 35 by a phase synchronization loop composed of the frequency divider 32 and the phase comparator 33. The voltage-controlled oscillator 31 generates a local oscillating signal having a fixed frequency and applies the local oscillating signal to the mixer 16, the mixer 16 mixes the local oscillating signal with the signals received at the antenna 10 and amplified by the low noise amplifier 11 to convert the local oscillating signal into a plurality of intermediate frequency signals at different frequencies, and the intermediate frequency signals are amplified by the intermediate frequency amplifier 17 and output to the signal processing means 103 via the connection point 61.

The signal processing means 103 is composed of the synchronous signal detector 51 that detects a synchronous signal from the intermediate frequency signal, the phase and frequency detector 52 that detects the frequency, phase and/or delay time of the intermediate frequency signal, the frequency multiplier/divider 56 that supplies a clock signal serving as a reference of frequency and/or phase measurement to the phase and frequency detector 52, the synchronous oscillator 53, and the control unit 54.

In a stand-by state, the frequency multiplier/divider 56 is set at a multiplier or divider (×P1) and waits for a radio frequency signal radiated from the signal transmitting means 101 (not shown) at a first timing.

The main part of the phase and frequency detector 52 detects the frequency and/or phase of the input signal by converting the intermediate frequency signal into digital signals in a cycle of the clock signal and calculating the sum of products thereof using a sine and a cosine look-up table or performing fast Fourier transformation as shown in FIG. 7 or by converting the intermediate frequency signals into IQ signals and then achieving the zero beat as shown in FIG. 8, for example.

When a signal transmitting means 101 transmits a first radio frequency signal containing the synchronous signal at the first timing, the synchronous signal detector 51 detects the synchronous signal, and the control unit 53 activates the control timing.

The difference in oscillation frequency, phase and/or delay time between a first intermediate frequency signal corresponding to the first radio frequency signal transmitted from the signal transmitting means 101 and the output signal of the clock signal oscillator 53, and the frequency and/or phase of the synchronous oscillator 53 is controlled to make the frequencies and/or phases of the signals agree with each other. Once the signals are synchronized, the synchronization detecting means in the synchronous oscillator 53 detects the synchronization, and once the synchronization is detected, the synchronization retaining means retains the synchronization.

While the synchronous oscillator 53 is retaining the synchronized state, the phase and frequency detector 52 detects the frequency and/or phase of the intermediate frequency signal, the signal transmitting means 101 then radiates second radio frequency signals that differs at least in frequency at a second timing, the control unit 54 switches the divider of the frequency multiplier/divider 56 to a multiplier/divider (×P2), and the phase and frequency detector 52 detects the frequency and/or phase of second intermediate frequency signals that differ at least in frequency output from the signal receiving means 102. The distance between the signal transmitting means 101 and the signal receiving means 102 can be measured with high accuracy based on the result of the detection.

As can be seen from the example shown in FIG. 8, the oscillator in the synchronous oscillator 53 incorporates a delay locked loop oscillator, a voltage-controlled quartz oscillator, a phase synchronization loop oscillator, a numerically controlled oscillator, or a digitally controlled oscillator capable of controlling the frequency and/or phase and retaining the frequency and/or phase in the synchronized state.

The same advantages can be achieved if a ΔΣ modulation is used in the phase synchronization loop oscillator.

In the case where the signal transmitting means 101 transmits a plurality of carrier signals or sub-carrier signals in parallel, band pass filters have to be inserted in the input side of the phase and frequency detector 52, and switching between the band pass filters has to be performed at the timing when the multiplier of the multiplier 56 is changed.

FIG. 2 is a diagram showing a relationship between signals in the embodiment 1. In FIG. 5, reference numerals 201 and 202 denote a first orthogonal signal and a second orthogonal signal transmitted from the signal transmitting means 101 (not shown), respectively, reference numerals 203a and 203b denote control start points out put from a control unit 9 (not shown), reference numerals 204a and 204b denote phase differences between the control start points 203a and 203b of the signal transmitting means and control start points 210a and 210b of the signal receiving means 102 (not shown), respectively, and reference numeral 205 denotes a first local oscillating signal generated in the signal receiving means 102, which does not necessarily have to be synchronized with the control start points 210a or 210b and has a fixed frequency because the divider of a signal frequency divider 24 is fixed.

Reference numerals 206 and 207 denote a first first intermediate frequency signal and a second first intermediate frequency signal output to correspond to the first orthogonal signal 201 and the second orthogonal signal 202 of the signal transmitting means 101, respectively, reference numerals 208 and 209 denote a first orthogonal signal and a second orthogonal signal generated in the signal receiving means 102 to correspond to the first orthogonal signal 201 and the second orthogonal signal 202 of the signal transmitting means 101, respectively, reference numerals 212 and 213 denote a first second intermediate frequency signal and a second second intermediate frequency signal output to correspond to the first orthogonal signal 201 and the second orthogonal signal 202 of the signal transmitting means 101, respectively, reference numerals 211a and 211b denote phases of the first second intermediate frequency signal and the second second intermediate frequency signal, respectively, and reference numerals 221 to 231 denote time axes.

The first orthogonal signal 201 and the second orthogonal signal 202 transmitted from the signal transmitting means 101 differ in frequency but are synchronized with a particular phase (a rise from a voltage of 0 in the drawing) at the control start points 203a and 203b of the control unit 9 (not shown) of the signal transmitting means 101 and therefore are orthogonal to each other.

On the other hand, the first local oscillating signal 205 generated in the signal receiving means 102 has a fixed frequency, so that the first first intermediate frequency signal 206 and the second first intermediate frequency signal 207 output from the signal receiving means 102 differ in frequency, and therefore, it is difficult to measure the phase difference without modification.

Thus, a second mixer 35 is provided in the signal receiving means 102 to output the first second intermediate frequency signal 212 and the second second intermediate frequency signal 213, and the phase difference is determined from the phases 211a and 211b of the first second intermediate frequency signal and the second second intermediate frequency signal.

To measure the phase difference between the first second intermediate frequency signal 212 and the second second intermediate frequency signal 213 of the signal receiving means 102, synchronization of the first second intermediate frequency signal and the clock signal output from the synchronous oscillator 53 is first established, the synchronized clock signal is supplied to the phase detector 52 to measure the frequency and/or phase of the first second intermediate frequency signal 212, and the clock signal retained in synchronization with the first second intermediate frequency signal 208 is supplied to the phase and frequency detector 52 to measure the frequency and/or phase of the second second intermediate frequency signal 213.

The phases 211a and 211b of the first and second second intermediate frequency signals 212 and 213 can be measured, so that the distance between the signal transmitting means 101 and the signal receiving means 102 can be measured with high accuracy.

If the signal transmitting means 101 can radiate the first orthogonal signal 201 and the second orthogonal signal 202 at the same time, the control start points 203a and 203b can be generated at the same time, so that the phase difference can be easily measured in the signal receiving means 102.

FIG. 4 is a diagram showing a relationship between signals in the first embodiment 1. In FIG. 4, reference numerals 201 and 202 denote a first orthogonal signal and a second orthogonal signal transmitted from the signal transmitting means 101 (not shown), respectively, reference numerals 203a and 203b denote control start points output from the control unit 9 (not shown), reference numerals 204a and 204b denote phase differences between the control start points 203a and 203b of the signal transmitting means 101 and control start points 210a and 210b of the signal receiving means 102 (not shown), respectively, and reference numeral 205 denotes a first local oscillating signal generated in the signal receiving means 102, which has a fixed frequency because the divider of the frequency divider 24 is fixed.

Reference numerals 206 and 207 denote a first intermediate frequency signal and a second intermediate frequency signal output to correspond to the first orthogonal signal 201 and the second orthogonal signal 202, respectively, reference numerals 208 and 209 denote a first orthogonal signal and a second orthogonal signal generated in the signal receiving means 102 to correspond to the first orthogonal signal 201 and the second orthogonal signal 202 of the signal transmitting means 101, respectively, reference numerals 212 and 213 denote a first second intermediate frequency signal and a second second intermediate frequency signal output to correspond to the first orthogonal signal 201 and the second orthogonal signal 202 of the signal transmitting means 101, respectively, reference numerals 211a and 211b denote phases of the first second intermediate frequency signal and the second second intermediate frequency signal, respectively, and reference numerals 221 to 231 denote time axes.

The first orthogonal signal 201 and the second orthogonal signal 202 transmitted from the signal transmitting means 101 differ in frequency but are synchronized with a particular phase (a rise from a voltage of 0 in the drawing) at the control start points 203a and 203b of the control unit 9 (not shown) of the signal transmitting means 101 and therefore are orthogonal to each other.

On the other hand, the first local oscillating signal 205 generated in the signal receiving means 102 has a fixed frequency, so that the first first intermediate frequency signal 206 and the second first intermediate frequency signal 207 output from the signal receiving means 102 differ in frequency, and therefore, it is difficult to measure the phase difference without modification.

To measure the phase difference between the first intermediate frequency signal 206 and the second intermediate frequency signal 207, synchronization of the first intermediate frequency and the synchronous oscillator 53 is first established, a first clock signal 214 is supplied to the phase detector 52 to measure the frequency and/or phase of the first intermediate frequency signal 206, and a second clock signal 215 retained in synchronization with the first intermediate frequency signal 206 is supplied to the phase detector 52 to measure the frequency and/or phase of the second intermediate frequency signal.

The phase difference 211b between the first and second intermediate frequency signals 206 and 207 can be measured, so that the distance between the signal transmitting means 101 and the signal receiving means 102 can be measured with high accuracy.

If the signal transmitting means 101 can radiate the first radio frequency signal 201 and the second radio frequency signal 202 at the same time, the control start points 203a and 203b occur at the same time, so that the phase difference can be easily measured.

FIG. 5 is a diagram showing another example of flows of signals in the third embodiment. In FIG. 5, reference numerals 201 and 202 denote a first orthogonal signal and a second orthogonal signal transmitted from the signal transmitting means 101 (not shown), respectively, reference numerals 203a and 203b denote control start points output from the control unit 9 (not shown), reference numerals 204a and 204b denote phase differences between the control start points 203a and 203b of the signal transmitting means and control start points 210a and 210b of the signal receiving means 102 (not shown), respectively, and reference numeral 205 denotes a first local oscillating signal generated in the signal receiving means 102, which does not necessarily have to be synchronized with the control start points 210a or 210b and has a fixed frequency because the divider of the signal frequency divider 24 is fixed.

Reference numerals 206 and 207 denote a first first intermediate frequency signal and a second first intermediate frequency signal output to correspond to the first orthogonal signal 201 and the second orthogonal signal 202 of the signal transmitting means 101, respectively, reference numerals 208 and 209 denote a first orthogonal signal and a second orthogonal signal generated in the signal receiving means 102 to correspond to the first orthogonal signal 201 and the second orthogonal signal 202 of the signal transmitting means 101, respectively, reference numerals 212 and 213 denote zero-beat outputs of a first second intermediate frequency signal and a second second intermediate frequency signal output to correspond to the first orthogonal signal 201 and the second orthogonal signal 202 of the signal transmitting means 101, respectively, reference numerals 211a and 211b denote direct current voltages associated with the phases of the first second intermediate frequency signal and the second second intermediate frequency signal, respectively, and reference numerals 221 to 231 denote time axes.

The first orthogonal signal 201 and the second orthogonal signal 202 transmitted from the signal transmitting means 101 differ in frequency but are synchronized with a particular phase (a rise from a voltage of 0 in the drawing) at the control start points 203a and 203b of the control unit 9 (not shown) of the signal transmitting means 101 and therefore are orthogonal to each other.

On the other hand, the first local oscillating signal 205 generated in the signal receiving means 102 has a fixed frequency, so that the first first intermediate frequency signal 206 and the second first intermediate frequency signal 207 output from the signal receiving means 102 differ in frequency, and therefore, it is difficult to measure the phase difference without modification.

Thus, a second mixer 35 is provided in the signal receiving means 102 to output a first second intermediate frequency signal 212 and a second second intermediate frequency signal 213, and the phase difference is determined from the phases 211a and 211b of the first second intermediate frequency signal and the second second intermediate frequency signal.

To measure the phase difference between the first second intermediate frequency signal 212 and the second second intermediate frequency signal 213 of the signal receiving means 102, the first second intermediate frequency and the first orthogonal signal 208 are first controlled to achieve a zero beat, the phase detector 52 measures the frequency and/or phase of the first second intermediate frequency signal 212, the second orthogonal signal 209 is supplied to the phase and frequency detector 52 in the state where the zero beat with the first second intermediate frequency signal 208 is retained, and the frequency and/or phase of the second second intermediate frequency signal 213 is measured.

The phases 211a and 211b of the first and second second intermediate frequency signals 212 and 213 can be measured, so that the distance between the signal transmitting means 101 and the signal receiving means 102 can be measured with high accuracy.

To achieve the zero beat, the frequency of the first first intermediate frequency signal and the frequency of the first orthogonal signal have to be adjusted to be equal to each other, and the frequency of the second first intermediate frequency signal and the frequency of the second orthogonal signal have to be adjusted to be equal to each other.

The same advantages can be achieved by changing the sampling frequency in conversion of the intermediate frequency signals into digital signals, instead of achieving the zero beat as described above.

FIG. 6 is a diagram showing an exemplary configuration of the phase and frequency detector according to the present invention. In FIG. 6, reference numerals 61, 64 and 65 denote connection points, reference numeral 521 denotes an analog-to-digital converter, reference numeral 522a denotes a multiply and accumulation logic to detect Sin signal, reference numeral 522b denotes a multiply and accumulation logic to detect Cos signal, and reference numeral 523 denotes an ArcTan calculator.

The intermediate frequency signal output from the signal receiving means 102 (not shown) is input via the connection point 61, converted into a digital signal by the analog-to-digital converter 521, branched into two, and applied to the multiply and accumulation logic to detect Sin signal 522a and the multiply and accumulation logic to detect Cos signal 522b.

The clock signal serving as a reference of frequency and/or phase measurement is input via the connection point 525, branched into three, and applied to the analog-to-digital converter 521, the multiply and accumulation logic to detect Sin signal 522a and the multiply and accumulation logic to detect Cos signal 522b.

The look-up table of the multiply and accumulation logic to detect Sin signal 522a uses (0, 1, 0, −1) as a base unit, and the look-up table of the multiply and accumulation logic to detect Cos signal 522b uses (1, 0, −1, 0) as a base unit, so that the product-sum operation can be advantageously processed in a short time.

The outputs of the multiply and accumulation logics 522a and 522b are input to the ArcTan calculator 523, which calculates the phase Φ (=ArcTan(Sin/Cos)), and the result is output to the control unit 54 (not shown) via the connection point 64.

The phase and frequency detector can also be used as the digital phase comparator incorporated in the synchronous oscillator, an example of which is shown in FIG. 9.

FIG. 7 is a diagram showing another configuration of the phase and frequency detector according to the present invention. In FIG. 7, reference numerals 61, 64 and 65 denote connection points, reference numerals 524a and 524b denote mixers, reference numerals 526a and 526b denote low pass filters, reference numerals 521a and 521b denote analog-to-digital converters, reference numeral 523 denotes an ArcTan calculator, and reference numeral 525 denotes a 90-degrees phase shifter.

The intermediate frequency signal output from the signal receiving means 102 (not shown) is input via the connection point 61, branched into two, and applied to the mixers 524a and 524b.

The clock signal serving as a reference of frequency and/or phase measurement is input via the connection point 525 and branched into two, one of which is directly input to the mixer 524a as a first local oscillating signal, and the other of which is phase-shifted by 90 degrees by the 90-degrees phase shifter 525 and then applied to the mixer 524b as a second local oscillating signal.

The mixer 524a outputs an I signal, the low pass filter 526a removes higher harmonics from the I signal, the resulting signal is converted into a digital signal by the analog-to-digital converter 521a, and the resulting digital signal is input to the ArcTan calculator 523 as an I signal.

The mixer 524b outputs a Q signal, the low pass filter 526b removes higher harmonics from the Q signal, the resulting signal is converted into a digital signal by the analog-to-digital converter 521b, and the resulting digital signal is input to the ArcTan calculator 523 as a Q signal.

The ArcTan calculator 523 calculates the phase difference Φ (=ArcTan(I/Q)), and the result is output to the control unit 54 (not shown) via the connection point 64.

The phase and frequency detector can also be used as the phase comparator incorporated in the synchronous oscillator, an example of which is shown in FIG. 9.

The frequency of the outputs of the mixers 526a and 526b can be set to be zero-beat (direct current), or phase measurement can be performed after the frequencies of the outputs of the mixers 526a and 526b are converted to any common frequency.

FIG. 8 is a diagram showing an exemplary configuration of the synchronous oscillator according to the present invention. In FIG. 8, reference numeral 53 denotes the synchronous oscillator, reference numeral 531 denotes a synchronization establishing/retaining circuit, reference numeral 532 denotes a digital phase comparator, reference numeral 533 denotes a digitally controlled oscillator, and reference numerals 67, 68, 69 and 70 denote connection points.

The intermediate frequency signal output from the signal receiving means 102 (not shown) is input via the connection point 61 as a synchronous input signal and coupled to the digital phase comparator 532 via the synchronization establishing/retaining circuit 531, which compares the phase of the synchronous input signal and the phase of the output signal of the digitally controlled oscillator 533, and the result of the comparison is input to the digitally controlled oscillator 533 as a control signal to control the frequency, phase and/or delay time of the digitally controlled oscillator 533 and then output via the connection point 68 as a synchronous output signal.

If the synchronous input signal and the synchronous output signal are synchronized with each other in frequency and/or phase, a synchronization detection signal is output to the control unit 54 (not shown) via the connection point 70, and a synchronization retention signal is input to the synchronization establishing/retaining circuit 531 from the control unit 54 via the connection point 69 to retain the oscillation frequency and/or phase of the digitally controlled oscillator 533.

The synchronization establishing/retaining circuit 531 is composed of an AND gate or OR gate, for example. If “0” or “1” is applied to the connection point 69, the output of the AND gate or OR gate is fixed to “0” or “1”, and a pseudo synchronized state is set to retain the output signal of the digital phase comparator 532 at OFF to retain the frequency and/or phase of the digitally controlled oscillator 533.

The oscillation frequency can be controlled by performing addition or subtraction of the output signal of the digital phase comparator 532 in a frequency setting register in the digitally controlled oscillator 533.

The digitally controlled oscillator 533 may be a voltage controlled oscillator controlled by a digital signal, a numerically controlled oscillator, or a digitally controlled oscillator capable of controlling the frequency, phase and/or delay time and setting and retaining a particular frequency, phase and/or delay time.

Furthermore, if a numerically controlled oscillator is used as the digitally controlled oscillator 533, by controlling the oscillation frequency and/or phase of the numerically controlled oscillator by the digital control signal output from the digital phase comparator 531 to achieve a synchronized state and retaining the digital signal to retain the synchronized state, there can be provided a synchronous oscillator that has a highly stable oscillation frequency and a short pull-in time and is stably controlled for pull-in and synchronization establishment/retention.

Furthermore, if and adder (accumulator) in the numerically controlled oscillator is reset at the control start points described above, the voltage zero point of the output signal can be easily controlled.

### Embodiment 4

FIG. 9 is a diagram showing a configuration of a distance measuring device according to a fourth embodiment of the present invention. In FIG. 9, reference numerals 1a and 1b denote a plurality of antennas connected to a signal transmitting means 101, reference numeral 1c denotes an antenna switching means for switching between the plurality of antennas 1a and 1b, reference numerals 10a and 10b denote a plurality of antennas connected to a signal receiving means 102, reference numeral 10c denotes an antenna switching means for switching between the plurality of antennas 10a and 10b, and reference numeral 66 denotes a connection point between the control unit 54 and the antenna switching means 10c. The remaining components are the same as those shown in FIG. 1.

The plurality of antennas 1a, 1b and/or the plurality of antennas 10a, 10b are disposed at intervals equal to or smaller than the wavelength of the carrier signal or sub-carrier signal of the radio frequency signal and periodically switched by the antenna switching means 1c or 10c controlled by the control unit 9 or 54 while the signal transmitting means 101 is transmitting the radio frequency signal or the signal receiving means 102 is receiving the radio frequency signal.

With the configuration described above, the distance between the signal transmitting means 101 and the signal receiving means 102 can be measured, and the direction of the position and/or movement of the signal transmitting means 101 and/or signal receiving means 102 can be determined with high accuracy. Thus, if a single signal transmitting means 101 is installed at a fixed position, the current position (distance and direction) of the signal receiving means 102 can be advantageously spotted with high accuracy. Alternatively, if a single signal receiving means 102 is installed at a fixed position, the current position (distance and direction) of the signal transmitting means 101 can be advantageously spotted with high accuracy.

For example, in a case where the signal transmitting means 101 is a base station of a cellular phone system, and the signal receiving means 102 is a mobile terminal, the position (distance and direction) of the mobile terminal can be spotted with high accuracy by receiving the radio signal from the base station.

In a case where a plurality of signal transmitting means 101 are disposed at different positions, the position of the signal receiving means 102 can be spotted with high accuracy by hyperbolic navigation or trigonometry by measuring the distance and direction thereof from the plurality of positions.

Even if the plurality of antennas 1a, 1b are sectored instead of switching between the plurality of antennas 1a, 1b of the signal transmitting means 101 by the switching means 1c, an approximate direction can be determined, so that an approximate position of the signal receiving means 102 can be spotted (however, the distance is accurate).

If the antennas 1a, 1b or 10a, 10b connected to the signal transmitting means 101 and/or signal receiving means 102 are two directional antennas disposed at intervals equal to or smaller than the wavelength of the signal transmitted from the signal transmitting means 101, and the two directional antennas are oriented horizontally or obliquely downward, the error of the direction measurement due to multi-path can be reduced, and the range of position (distance and direction) spotting can be expanded.

The circuit configuration is the same as that of the circuit for measuring only the distance except that the signal transmitting means 101 and/or signal receiving means 102 has a plurality of antennas 1a, 1b and/or 10a, 10b and an antenna switching means 1c and/or 10c, the cost increase due to addition of the direction measurement function to the distance measurement function can be reduced.

FIG. 10 is a conceptual diagram illustrating position spotting based on the result of distance measurement by the distance measuring device according to the present invention. In FIG. 10, reference numeral 301 denotes a signal transmitting means or signal receiving means disposed at a relatively high position, reference numeral 302 denotes a signal transmitting means or signal receiving means disposed or moving at a relatively low position, reference numeral 303 denotes the ground, a floor or the like, reference numeral 311 denotes the distance (L m) measured by the measurement method described above, reference numeral 312 denotes the height difference (H m) between the relatively high position and the relatively low position, reference numeral 313 denotes the height (h m) of the relatively low position, and reference numeral 314 denotes the horizontal distance (D m).

Once the distance 311 (L m) is determined by the measurement method described above, the horizontal distance 314 (D m) can be easily calculated by the known triangle theorem.

The signal transmitting means or signal receiving means 301 disposed at a relatively high position is installed on a column or ceiling, for example, and the signal transmitting means or signal receiving means 302 disposed or moving at a relatively low position is carried by a walking person or mounted on a mobile body, for example.

Depending on the geographical condition around the signal transmitting means or signal receiving means 301 disposed at a relatively high position, a more complicated calculation may be required, so that it is advantageous for the signal transmitting means or signal receiving means 301 disposed at a relatively high position to transmit information about the geographical condition around the signal transmitting means or signal receiving means 301.

In addition, if the direction of the position or movement of the signal transmitting means or signal receiving means can be detected, the position of the signal transmitting means or signal receiving means can be spotted.

In the above description, the digital phase comparator is used. The phase comparator can be implemented by performing phase measurement using a hardware-based multiply and accumulation logic, performing phase measurement by FFT calculation by software running on a DSP or microcomputer, or using an existing technique. Software calculation takes a longer processing time and thus is not suitable for real-time processing, so that hardware processing is more advantageous in terms of processing time, power consumption, cost and the like.

Alternatively, the same advantages can be achieved if the signal transmitting means transmits an ultrasonic signal using an ultrasonic transducer or ultrasonic transmitter, and the signal receiving means receives the ultrasonic signal using an ultrasonic transducer or ultrasonic receiver, or the signal transmitting means transmits an optical signal using a light emitting diode or a laser diode, and the signal receiving means receives the optical signal using a photodiode.

Alternatively, the same advantages can be achieved if the signal transmitting means generates modulation signals or baseband signals synchronized with the reference oscillator or a plurality of modulation signals or baseband signals orthogonal to each other and transmits ultrasonic, radio frequency or optical carrier signals or sub-carrier signals modulated therewith, and the signal receiving means generates a local oscillating signal synchronized with the reference oscillator and mixes the local oscillating signal with the received modulation signals or baseband signals to convert the local oscillating signal into modulation signals or baseband signals at a common frequency.

In a case where the common carrier signal or sub-carrier signal transmitted from the signal transmitting means is spread by a plurality of spread spectrum codes that differ at least in chip rate and are synchronized with or orthogonal to each other, a plurality of synchronous signals that differ in chip rate and are used for producing a plurality of spread spectrum codes used for despreading of the spread common carrier signal or sub-carrier signal received by the signal receiving means can be used as the plurality of modulation signals or baseband signals described above.

Furthermore, measurement error due to multi-path or height pattern can be reduced if the signal transmitting means switches between the plurality of antennas or transceivers connected to the signal transmitting means and/or signal receiving means at the timing when the plurality of signals that differ at least in frequency and are synchronized with or orthogonal to each other are generated, thereby measuring the distance between the signal transmitting means and the signal receiving means and the direction from one of the signal transmitting means and the signal receiving means to the other.

Furthermore, the same advantages can be achieved if the signal transmitting means uses an ultra wide band (UWB) spread spectrum code to convert into an ultrasonic signal, radio frequency signal or optical signal before transmission. In this case, the intervals between the plurality of antennas or the plurality of transmitters or receivers are equal to or smaller than a distance corresponding to the chip rate of the spread spectrum code.

The distance measurement method can be generally applied to systems that require spotting of distance or both distance and direction, such as mobile radio systems, including cellular phone systems, and survey systems.

The accuracy of distance measurement can be improved if the distance between the signal transmitting means and the signal receiving means is measured a plurality of times, and the measurements are statistically processed to estimate a propagation path distribution of the ultrasonic signals, radio frequency signals or optical signals transmitted from the signal transmitting means or a multi-path occurrence.

Alternatively, the propagation path distribution or multi-path occurrence can be estimated by comparison between the distribution determined based on the plurality of distance measurements and a distance measurement distribution model.

Furthermore, distances can be measured based on the plurality of signals received by the signal receiving means with the measurement range changing stepwise from a long range to a short range by changing stepwise the variation in frequency or chip rate of the plurality of signals transmitted from the signal transmitting means.

### INDUSTRIAL APPLICABILITY

With the configuration described above, according to the present invention, if a single signal transmitting means or a single signal receiving means is installed at a fixed position, the distance between the signal transmitting means and the signal receiving means can be measured with high accuracy, and position spotting can be achieved with higher accuracy if the direction or the direction of movement is additionally measured.

Since the present invention can achieve position spotting with high accuracy, the present invention can be applied to a pedestrian supporting system that guides a person who walks across a crossing to prevent him/her from deviating from the crosswalk.

Furthermore, since the direction and distance from a single base station to a mobile terminal in a mobile radio system can be measured, an accurate car navigation system or pedestrian navigation system can be provided.

Furthermore, if an active tag is used as the signal transmitting means, and a plurality of base stations serving as signal receiving means are interconnected by a network, the position of the active tag can be accurately detected. Thus, the present invention can be used in commercial applications, such as traffic line management for surveying migration paths of customers, physical distribution management for improving the efficiency of transfer and accumulation of goods, and search for lost children.

Furthermore, the present invention can be used for biotelemetry if the active tag is attached to livestock or wild animals to accurately determine the positions thereof.

Furthermore, distance and direction survey can be achieved with high accuracy by installing the signal receiving means on a transit and the signal transmitting means on a pole. In the case of survey, real-time processing is not essential, so that the accuracy of survey can be improved by extending the length of time of data acquisition to increase the number of pieces of data.

Furthermore, since the present invention can accurately measure the distance and the direction between ships under steam, aircrafts in flight or running vehicles, the present invention can be applied to systems for preventing collisions or maintaining relative distances.

Furthermore, an inexpensive remote controller for a mobile body can be provided because the relative positional relationship between the mobile body and the operator can be accurately determined by one-to-one communication between the mobile body and the operator.

The distance measurement technology according to the present invention is a fundamental technology and thus can be applied to many other fields.

### BRIEF DESCRIPTION OF THE DRAWINGS

FIG. 1 is a diagram showing a configuration of a distance measuring device according to an embodiment 1 of the present invention;

FIG. 2 is a diagram showing an example of flows of signals in the embodiment 1;

FIG. 3 is a diagram showing a configuration of a distance measuring device according to an embodiment 2 of the present invention;

FIG. 4 is a diagram showing an example of flows of signals in the embodiment 2;

FIG. 5 is a diagram showing another example of flows of signals in the embodiment 2;

FIG. 6 is a diagram showing an exemplary configuration of a phase and frequency detector;

FIG. 7 is a diagram showing another exemplary configuration of the phase and frequency detector;

FIG. 8 is a diagram showing an exemplary configuration of a synchronous oscillator;

FIG. 9 is a diagram showing a configuration of a distance measuring device according to an embodiment 3 of the present invention;

FIG. 10 is a conceptual diagram illustrating position spotting based on the result of distance measurement; and

FIG. 11 is a block diagram showing a prior art example.

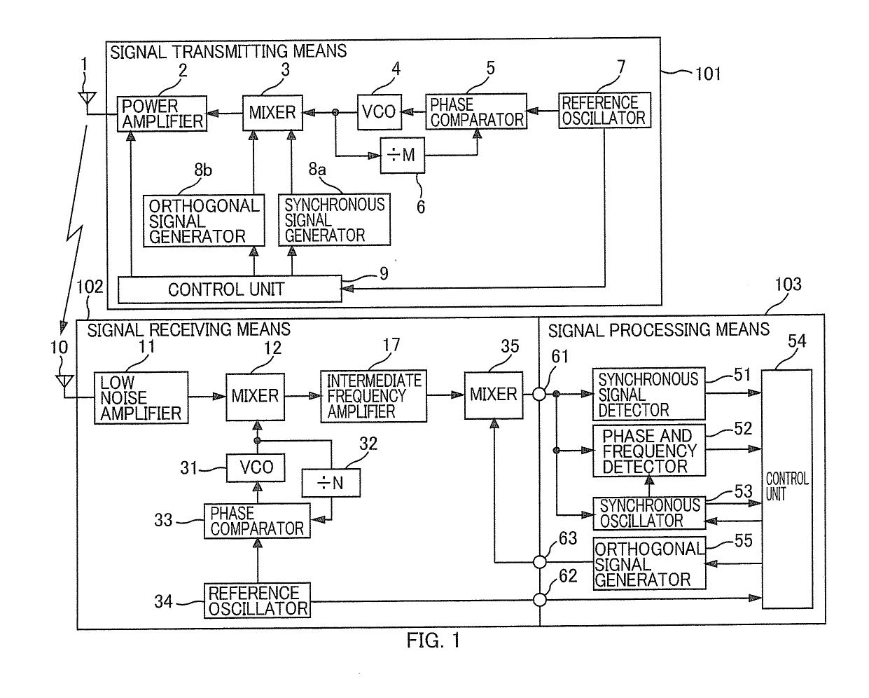

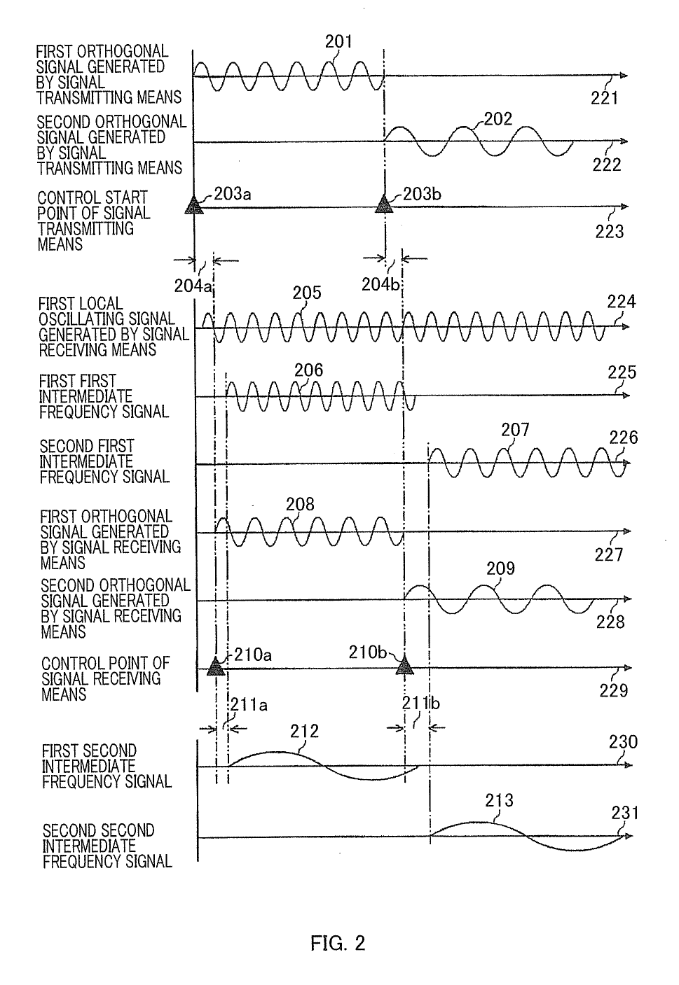

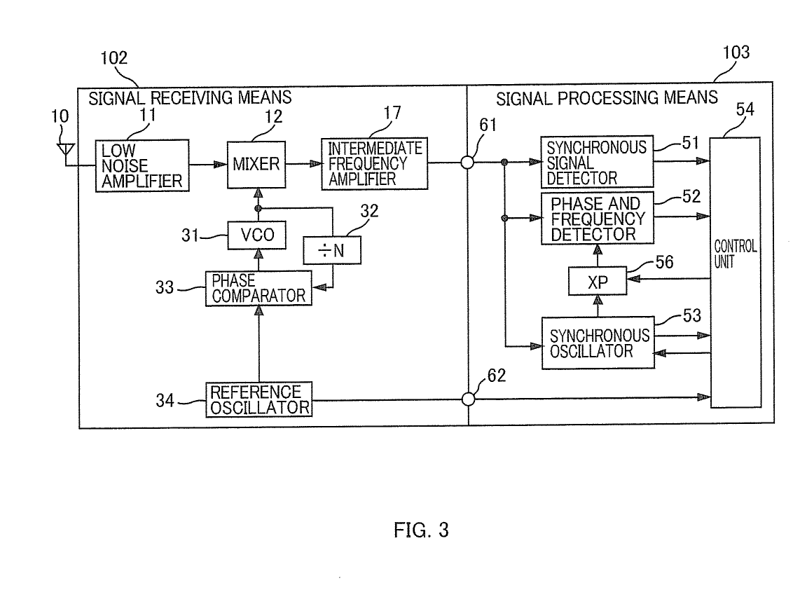

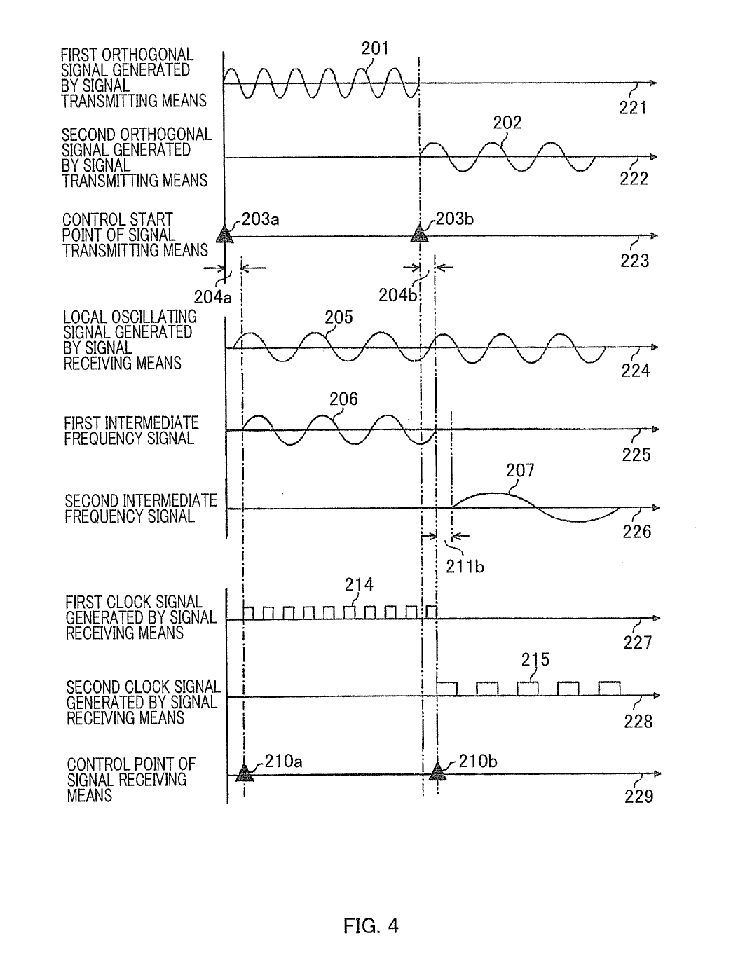

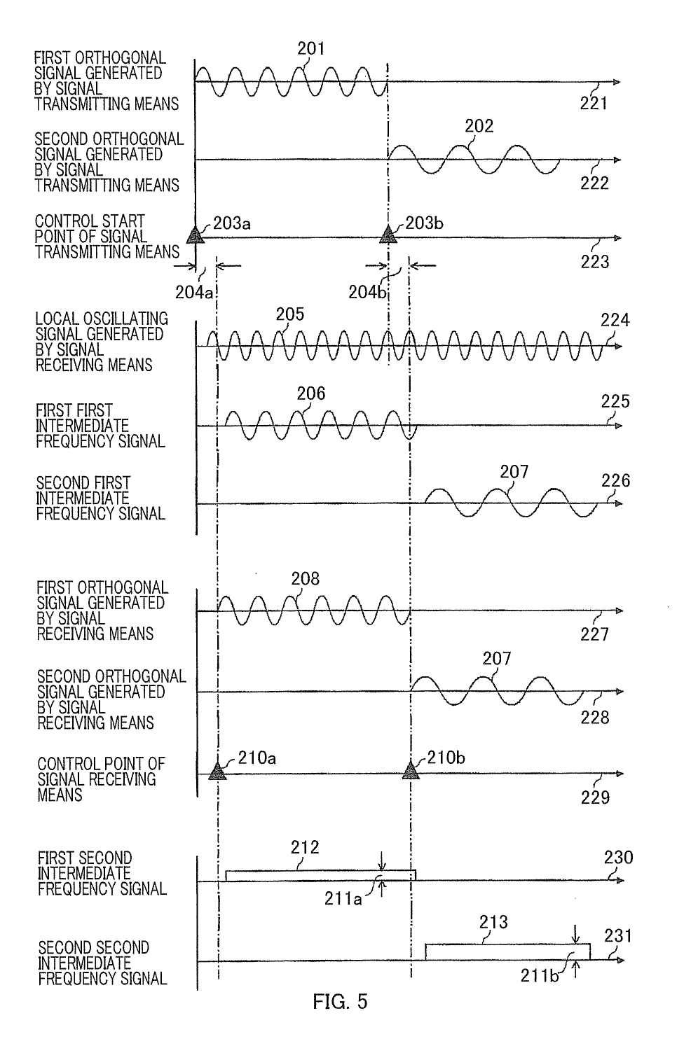

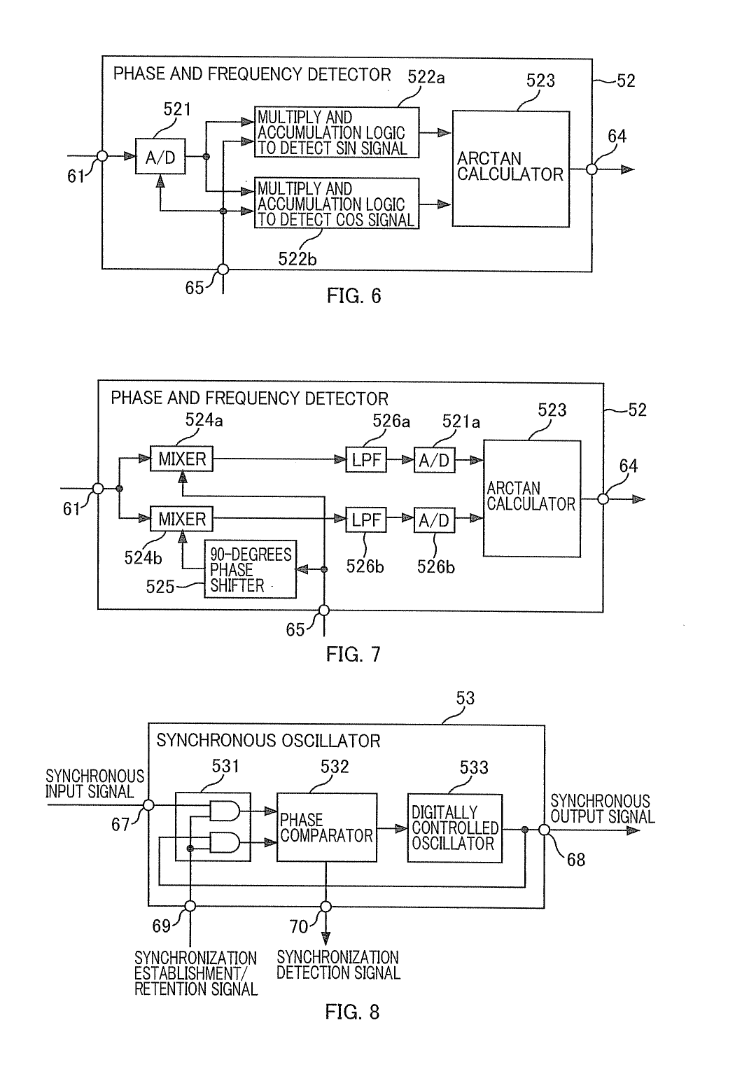

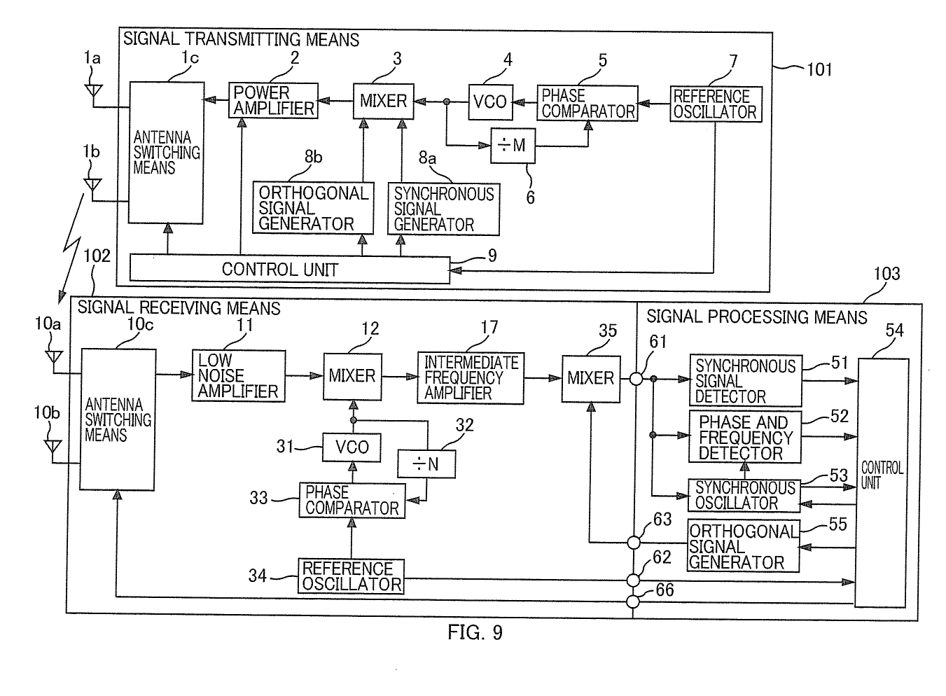

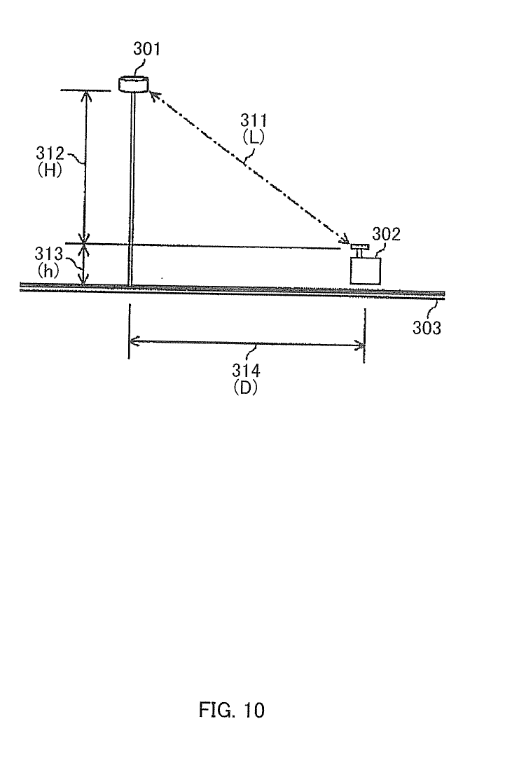

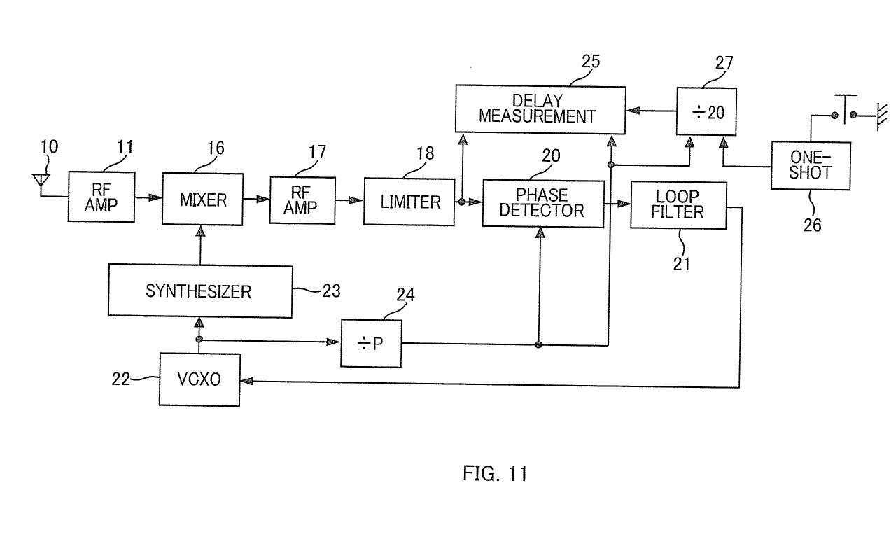

### DESCRIPTION OF SYMBOLS

1 antenna
1a, 1b a plurality of antennas
1c antenna switching means
2 power amplifier
3 mixer
4 voltage-controlled oscillator
5 phase comparator
6 frequency divider
7 reference oscillator
8a synchronous signal generator
8b FSK signal generator
9 control unit
10 antenna
10a, 10b a plurality of antennas
10c antenna switching means
11 low noise amplifier
16 first mixer
17 intermediate frequency amplifier
31 voltage-controlled oscillator
32 frequency divider
33 phase comparator
34 reference oscillator
35 second mixer
51 synchronous signal detector
52 phase and frequency detector
53 synchronous oscillator
54 control unit
55 orthogonal signal generator
56 frequency multiplier/divider
61-70 connection point
101 signal transmitting means
102 signal receiving means
103 signal processing means
201, 202 first and second orthogonal signals
203a, 203b control start point
204a, 204b phase difference between transmission control start point and reception control start point
205 first local oscillating signal generated by signal receiving means
206, 207 first and second first intermediate frequency signals
208, 209 first and second orthogonal signals
210a, 210b control start point
211a, 211b phase difference between first and second second intermediate frequency signals
212, 213 first and second second intermediate frequency signals
214, 215 first and second clock signals
221-231 time axes for signals
301 signal transmitting means or signal receiving means disposed at relatively high position
302 signal transmitting means or signal receiving means disposed or moving at relatively low position
303 ground, floor or the like
311 distance (L m) measured by measurement method described above
312 difference in height (H m) between relatively high position and relatively low position
313 height (h m) of relatively low position
314 horizontal distance (D m)
521, 521a analog-to-digital converter
521b analog-to-digital converter
522a multiply and accumulation logic to detect Sin signal
522b multiply and accumulation logic to detect Cos signal
523 ArcTan calculator
524a, 524b mixer
525 90-degrees phase shifter
526a, 526b low pass filter
531 digital phase comparator
532 synchronization establishing/retaining means
533 digitally controlled oscillator

1-36. (canceled)

37. A distance measuring device in a system that performs distance measurement using an ultrasonic signal, radio frequency signal or optical signal comprising:
a signal transmitting means that transmits an ultrasonic signal, radio frequency signal or optical signal containing a plurality of measuring signals that differ at least in frequency and are synchronized with or orthogonal to each other;
a signal receiving means that receives the ultrasonic signal, radio frequency signal or optical signal transmitted from said signal transmitting means, reproduces said plurality of measuring signals, and mixes or despread the plurality of reproduced signals with a plurality of local oscillating signals that differ at least in frequency and are synchronized with or orthogonal to each other to convert the plurality of reproduced signals into intermediate frequency signals, modulation signals or baseband signals having a common frequency; and
a signal processing means that processes said intermediate frequency signal, modulation signal or baseband signals output from said signal receiving means to achieve distance measurement,
wherein said signal processing means detects the frequency and/or phase of a first intermediate frequency signal, modulation signal or baseband signal corresponding to a first measuring signal serving as a reference, detects the frequency and/or phase of a second intermediate frequency signal, modulation signal or baseband signal corresponding to a second measuring signal that differs from the first measuring signal serving as a reference at least in frequency, and determine the distance between said signal transmitting means and said signal receiving means based on the result of the detections.

38. The distance measuring device according to claim 37, wherein said measuring signals are carrier signals, sub-carrier signals, spread spectrum codes, modulation signals and/or baseband signals.

39. The distance measuring device according to claim 37, wherein said signal processing means has a synchronous oscillator capable of controlling the frequency, phase and/or delay time, a synchronization establishing/retaining means that establishes and retains a synchronization between a clock signal output from said synchronous oscillator and said intermediate frequency signals, modulation signals or baseband signals, and a phase and frequency detector that detects the frequency and/or phase of said intermediate frequency signals, modulation signals or baseband signals with reference to the clock signal output from said synchronous oscillator, and
said synchronization establishing/retaining means controls said synchronous oscillator to establish a synchronization between the first intermediate frequency signal, modulation signal or baseband signal corresponding to the first measuring signal serving as a reference and the clock signal output from said synchronous oscillator, and the frequency and/or phase of said intermediate frequency signals, modulation signals or baseband signals is detected in a state where the synchronization between said first intermediate frequency signal, modulation signal or baseband signal and the clock signal is retained.

40. The distance measuring device according to claim 37, wherein the frequency, phase and/or delay time of a local oscillating signal oscillator in said signal receiving means can be controlled, and
said synchronization establishing/retaining means controls said local oscillating signal oscillator to establish a synchronization between said first intermediate frequency signal, modulation signal or baseband signal serving as a reference and a clock signal output from a clock oscillator having a fixed frequency, phase and/or delay time, and the frequency and/or phase of said second intermediate frequency signal, modulation signal or baseband signal is detected in a state where the synchronization between said first intermediate frequency signal, modulation signal or baseband signal and said clock signal is retained, and the distance between said signal transmitting means and said signal receiving means is determined based on the result of the detection.

41. The distance measuring device according to claim 37, wherein, in said signal receiving means, said plurality of reproduced measuring signals are mixed with a local oscillating signal having a fixed or semifixed frequency to convert the plurality of reproduced measuring signals into a plurality of intermediate frequency signals, modulation signals or baseband signals that differ at least in frequency,
the frequency, phase and/or delay time of the synchronous oscillator in said signal processing means can be controlled,
said synchronization establishing/retaining means controls said synchronous oscillator to establish a synchronization between said first intermediate frequency signal, modulation signal or baseband signal serving as a reference and a clock signal output from said synchronous oscillator, the frequency and/or phase of said first intermediate frequency signal, modulation signal or baseband signal is detected in a state where the synchronization between said first intermediate frequency signal, modulation signal or baseband signal and the clock signal is retained, the frequency of said clock signal is then multiplied or divided to convert the clock signal into a clock signal corresponding to said second intermediate frequency signal, modulation signal or baseband signal having a different frequency, the frequency and/or phase of said second intermediate frequency signal, modulation signal or baseband signal is detected with reference to said converted clock signal, and the distance between said signal transmitting means and said signal receiving means is determined based on the result of the detection.

42. The distance measuring device according to claim 37, wherein, in said signal receiving means, said plurality of reproduced measuring signals are mixed with a first local oscillating signal having a fixed or semi-fixed frequency to convert the plurality of reproduced measuring signals into a plurality of first intermediate frequency signals, modulation signals or baseband signals that differ at least in frequency,
the frequency, phase and/or delay time of a second local oscillating signal oscillator in said signal receiving means or signal processing means can be controlled,
said plurality of first intermediate frequency signals, modulation signals or baseband signals that differ at least in frequency are mixed with said second local oscillating signal to convert the plurality of first intermediate frequency signals, modulation signals or baseband signals into second intermediate frequency signals, modulation signals or baseband signals that are the same at least in frequency,
said signal processing means has a synchronous oscillator capable of controlling the frequency, phase and/or delay time, a synchronization establishing/retaining means that establishes and retains a synchronization between a clock signal output from said synchronous oscillator and said second intermediate frequency signals, modulation signals or baseband signals, and a phase and frequency detector that detects the frequency and/or phase of said second intermediate frequency signals, modulation signals or baseband signals with reference to the clock signal output from said synchronous oscillator, and
said synchronization establishing/retaining means controls said synchronous oscillator to establish a synchronization between a first second intermediate frequency signal, modulation signal or baseband signal corresponding to the first measuring signal serving as a reference and the clock signal output from said synchronous oscillator, and the frequency and/or phase of said second intermediate frequency signals, modulation signals or baseband signals is detected in a state where the synchronization between said first second intermediate frequency signal, modulation signal or baseband signal and the clock signal is retained.

43. The distance measuring device according to claim 37, wherein, in said signal receiving means, said plurality of reproduced measuring signals are mixed or modulated with a spread code output from a spread code oscillator the chip rate, phase and/or delay time of which can be controlled to convert the plurality of reproduced measuring signals into intermediate frequency signals, modulation signals or baseband signals having a common frequency, and
said synchronization establishing/retaining means controls said spread code oscillator to establish a synchronization between said reproduced first spread code serving as a reference and a spread code output from said spread code oscillator, the frequency and/or phase of said reproduced first spread code is detected in a state where the synchronization with said reproduced first spread code is retained, said spread code oscillator then oscillates a second spread code that is orthogonal to the first spread code and differs from the first spread code at least in chip rate, the frequency and/or phase of the reproduced second spread code is detected, and the distance between said signal transmitting means and said signal receiving means is determined based on the result of the detections.

44. The distance measuring device according to claim 37, wherein said signal transmitting means transmits said first measuring signal and said second measuring signal by changing the phase difference between the first measuring signal and the second measuring signal plurality of times, and said signal receiving means perform measurement in response to the plurality of times of changes of the phase difference between said first measuring signal and said second measuring signal, thereby improving the accuracy of distance measurement.

45. The distance measuring device according to claim 37, wherein the plurality of measuring signals generated in said signal transmitting means that differ at least in frequency and are synchronized with or orthogonal to each other are composed of a variable part and a fixed part, the plurality of local oscillating signals generated in said signal receiving means that differ at least in frequency and are synchronized with or orthogonal to each other are composed of a variable part and a fixed part, and at least the variable part of the measuring signals generated in said signal transmitting means and the variable part of the local oscillating signals generated in said signal receiving means are equal, similar or analogous to each other.

46. The distance measuring device according to claim 37, wherein a plurality of antennas or transceivers connected to said signal transmitting means and/or signal receiving means are periodically switched in response to said signal transmitting means generating the plurality of measuring signals that differ at least in frequency and are synchronized with or orthogonal to each other, thereby determining the distance and direction between said signal transmitting means and said signal receiving means.

47. The distance measuring device according to claim 37, wherein, in said signal transmitting means and/or signal receiving means, the plurality of measuring signals that differ at least in frequency and are synchronized with or orthogonal to each other are generated by using a particular frequency, phase, delay time and/or timing as a control start point, by using a fixed control start point and generating a plurality of spread codes or performing hopping between a plurality of frequencies, chirp modulation or frequency shift keying between a plurality of frequencies, or by using a fixed control start point and performing amplitude modulation, double side band modulation or single side band modulation with an arbitrary modulation signal or baseband signal.

48. The distance measuring device according to claim 37, wherein, during a plurality of generations of the plurality of measuring signals that differ at least in frequency and are synchronized with or orthogonal to each other, the intervals between the control start points corresponding to said plurality of measuring signals are equal to or integer multiples of each other, or the numbers of cycles of said plurality of measuring signals generated at intervals of said control start points are multiples of or equal to each other.

49. The distance measuring device according to claim 48, wherein said control start points are zero crossing points or particular points of the plurality of measuring signals, and activation or generation of a measuring signal is started in synchronization with the zero crossing point or particular point of the immediately preceding measuring signal, and the variation to a measuring signal from the immediately preceding signal is smooth and continuous.

50. The distance measuring device according to claim 37, wherein, in a case where the plurality of measuring signals synchronized with or orthogonal to the reference oscillator transmitted from said signal transmitting means are spread by a spread spectrum code, said plurality of measuring signals are reproduced by despreading or frequency multiplication.

51. The distance measuring device according to claim 37, wherein said signal transmitting means transmits an ultrasonic signal, radio frequency signal or optical signal modulated with a plurality of modulation signals or baseband signals that differ at least in frequency and are synchronized with or orthogonal to each other, and
said receiving means receives said ultrasonic signal, radio frequency signal or optical signal, demodulates said plurality of modulation signals or baseband signals, and mixes said plurality of demodulated modulation signals or baseband signals with a plurality of local oscillating signals that differ at least in frequency and are synchronized with or orthogonal to each other to convert the plurality of demodulated modulation signals or baseband signals into intermediate frequency signals having a common frequency.

52. The distance measuring device according to claim 37, wherein said local oscillating signal oscillator and/or synchronous oscillator starts oscillation from a particular frequency, phase and/or delay time, are set, reset or switched to a particular frequency, phase and/or delay time, or are synchronized with the frequency, phase and/or delay time of a particular signal at said control start points.

53. The distance measuring device according to claim 37, wherein said local oscillating signal oscillator, synchronous oscillator and/or spread code oscillator has a digital phase comparator or digital delay locked loop that detects the phase difference between the plurality of measuring signals as a digital signal and a digitally controlled oscillator capable of controlling the frequency, phase and/or delay time using said digital signal and is capable of establishing a synchronization between a plurality of signals input to said phase comparator or delay locked loop and retaining said synchronization.

54. The distance measuring device according to claim 53, wherein a register that sets the oscillation frequency and/or oscillation phase of a numerically controlled oscillator is set or reset at said control start points.

55. The distance measuring device according to claim 37, wherein, in said phase and frequency detector, the frequency and/or phase of said intermediate frequency signals, modulation signals or baseband signals is detected by converting said intermediate frequency signals, modulation signals or baseband signals into digital signals by an analog-to-digital converter and performing the multiply and accumulation operation of said digital signals using a sine look-up table using (0, 1, 0, −1) as a base unit and a cosine look-up table using (1, 0, −1, 0) as a base unit.

56. The distance measuring device according to claim 37, wherein, in said phase and frequency detector, the frequency and/or phase of said intermediate frequency signals, modulation signals or baseband signals is detected by outputting I/Q signals by direct conversion of said intermediate frequency signals, modulation signals or baseband signals or achieving a zero beat and converting the I/Q signals into a digital signals by an analog-to-digital converter.

57. The distance measuring device according to claim 37, wherein, in said signal processing means, a window function is provided over a plurality of cycles of said intermediate frequency signals, modulation signals or baseband signals, and/or a plurality of clock signals serving as a reference are generated by branching, frequency division or frequency multiplication of clock signals output from a clock signal oscillator that correspond to said intermediate frequency signals, modulation signals or baseband signals, and the frequency and/or phase of said intermediate frequency signals, modulation signals or baseband signals is calculated in real time.

58. The distance measuring device according to claim 37, wherein said signal processing means has a statistical processing means that statistically processes the result of a plurality of measurements of the distance between said signal transmitting means and said signal receiving means and uses the statistical processing means to estimate a propagation path distribution of the ultrasonic signal, radio frequency signal or optical signal transmitted from said signal transmitting means or height pattern or multi-path occurrence and improve the accuracy of the distance measurement based on the result of the estimation.

59. The distance measuring device according to claim 58, wherein, in said statistical processing means, the distance from a particular signal transmitting means is measured successively a plurality of times or measured by switching between a plurality of antennas or transceivers, and said propagation path distribution or multi-path occurrence is estimated by comparing the distribution of the measurement results with a distance measurement distribution model.

60. The distance measuring device according to claim 58, wherein, in said statistical processing means, measurement of the distance from a particular signal transmitting means is performed successively a plurality of times and/or performed for each antenna of a particular signal transmitting means and/or signal receiving means, the accuracy of distance measurement can be improved by estimating a propagation path distribution of said distance measuring signals or multi-path occurrence, and/or a weighted average or moving average of relatively short distance measurement results is determined.

61. The distance measuring device according to claim 37, wherein the ultrasonic signal, high frequency signal or optical signal transmitted from said signal transmitting means contains an identification signal that allows identification of said signal transmitting means and/or information about said signal transmitting means.

62. The distance measuring device according to claim 37, wherein the plurality of measuring signals transmitted from said signal transmitting means are transmitted by being multiplexed and/or in a time-sharing manner.

63. The distance measuring device according to claim 37, wherein said signal transmitting means and said signal receiving means are installed at different heights, the difference in height is known, and the horizontal distance between said signal transmitting means and said signal receiving means is determined based on the result of measurement of the distance between said signal transmitting means and said signal receiving means.

64. The distance measuring device according to claim 37, wherein said signal receiving means has a plurality of antennas or transceivers and switching means that switches between the plurality of antennas or transceivers, and the direction of said signal receiving means and/or signal transmitting means, the direction of movement of said signal receiving means and/or signal transmitting means and/or the distance between said signal receiving means and said signal transmitting means is detected.

65. The distance measuring device according to claim 37, wherein said signal transmitting means is a base station in a mobile radio system, and said signal receiving means is a mobile terminal in the mobile radio system.

66. The distance measuring device according to claim 37, wherein said signal receiving means is a base station in a mobile radio system, and said signal transmitting means is a mobile terminal in the mobile radio system.

67. The distance measuring device according to claim 37, wherein said signal receiving means is fixed at a reference point or on a transit in a survey system, said signal transmitting means is installed at a standing point or on a pole, and the distance to the standing point or pole and the direction and/or height of the standing point or pole are measured.

68. The distance measuring device according to claim 37, wherein the signal receiving means are discretely installed at intervals, said signal transmitting means is attached to a mobile body, carried by a mobile body or fixed at an observation point, and the position or variation in position of said signal transmitting means is spotted.

69. The distance measuring device according to claim 37, wherein the signal transmitting means are discretely installed at intervals, said signal receiving means is attached to a mobile body, carried by a mobile body or fixed at an observation point, and the position or variation in position of said signal receiving means is spotted.

70. The distance measuring device according to claim 37, wherein said signal transmitting means and said signal receiving means are attached to or carried by the same mobile body or different mobile bodies.

71. The distance measuring device according to claim 37, wherein said signal transmitting means includes the signal receiving means and transmits the ultrasonic signal, high frequency signal or optical signal containing said plurality of carrier signals or sub-carrier signals that differ at least in frequency and are synchronized with or orthogonal to each other in response to receiving a transmission request transmitted from another signal transmitting means.

72. The distance measuring device according to claim 37, wherein distances are measured based on the plurality of signals received by said signal receiving means by changing the range stepwise from a long range to a short range by changing stepwise the variation in frequency or chip rate between the plurality of signals transmitted from said signal transmitting means.
